(19) United States
(12) Patent Application Publication
(10) Pub. No.: US 2024/0409763 A1
(43) Pub. Date: Dec. 12, 2024

(54) RECORDING HEAD FILLING LIQUID, INK SET, AND RECORDING HEAD INSPECTION METHOD

(71) Applicant: KYOCERA Document Solutions Inc., Osaka (JP)

(72) Inventor: Noriaki OZAWA, Osaka-shi (JP)

(73) Assignee: KYOCERA Document Solutions Inc., Osaka (JP)

(21) Appl. No.: 18/676,321

(22) Filed: May 28, 2024

(30) Foreign Application Priority Data
Jun. 8, 2023 (JP) 2023-094772

(51) Int. Cl. C09D 11/38; B41J 2/155; B41J 2/165; C09D 11/40

(52) U.S. Cl. CPC C09D 11/38; B41J 2/155; B41J 2/16579; C09D 11/40

(57) ABSTRACT

A recording head filling liquid contains a specific moisturizing agent, a monovalent alkali, and water. The specific moisturizing agent is a compound represented by general formula (1) below. The specific moisturizing agent has a percentage content of at least 19.00% by mass and no greater than 42.00% by mass. The recording head filling liquid has a static surface tension at 25° C. of at least 20.0 mN/m and no greater than 29.0 mN/m.

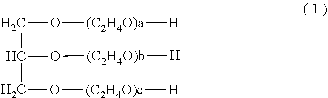

In general formula (1), a, b, and c each represent, independently of one another, an integer of at least 1 and a+b+c is at least 4 and no greater than 20.

### INCORPORATION BY REFERENCE

The present application claims priority of Japanese Patent Application No. 2023-094772 under 35 U.S.C. § 119, filed on Jun. 8, 2023. The contents of this application are incorporated herein by reference in their entirety.

### BACKGROUND

The present disclosure relates to a recording head filling liquid, an ink set, and a recording head inspection method.

Inkjet recording apparatuses include a recording head that ejects an inkjet ink. Generally, the recording head is thoroughly inspected for ejection performance and the like before shipping. The recording heads are filled with the inkjet ink for an ejection test in the inspection of the ejection performance.

However, the recording head, which is shipped with the inkjet ink remaining in its ink flow channel may have agglomerate of the solids (particularly, the pigment components) of the inkjet ink generated due to solvent evaporation in the inkjet ink during transportation and storage. The agglomerate causes ejection failure in the shipped recording head.

Therefore, recording head manufacturers may ship the recording head with the recording head filled with a solution that does not contain the pigment components (also referred to below as recording head filling liquid). The recording head filling liquid is required to be capable of being purged from the recording head when it is left unused for a while.

The recording head filling liquid enters the ink flow channel of the recording head and dilutes the inkjet ink remaining in the ink flow channel. Therefore, the recording head filling liquid is also required to be easily introduced into the ink flow channel within the recording head.

For example, a recording head filling liquid is proposed that contains silicone oil.

### SUMMARY

A recording head filling liquid according to an aspect of the present disclosure contains a specific moisturizing agent, a monovalent alkali, and water. The specific moisturizing agent is a compound represented by general formula (1) below. The specific moisturizing agent has a percentage content of at least 19.00% by mass and no greater than 42.00% by mass. The recording head filling liquid has a static surface tension at 25° C. of at least 20.0 mN/m and no greater than 29.0 mN/m.

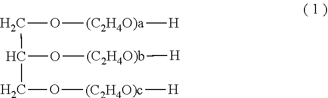

In the general formula (1), a, b, and c each represent, independently of one another, an integer of at least 1 and a+b+c is at least 4 to no greater than 20.

An ink set according to another aspect of the present disclosure includes an inkjet ink and the aforementioned recording head filling liquid.

A recording head inspection method according to still another aspect of the present disclosure uses the ink set described above and includes: inspecting ejection performance of a recording head; and filling the recording head filling liquid into the recording head after the inspecting. In the inspecting, the ejection performance of the recording head is inspected by causing the recording head to eject the inkjet ink.

### DETAILED DESCRIPTION

The following describes embodiments of the present disclosure. Note that in the following, measurement values for volume median diameter (D₅₀) are values as measured using a dynamic light scattering type particle size distribution analyzer (e.g., “ZETASIZER® NANO ZS” product of Malvern Instruments Ltd.) unless otherwise stated.

In the following, measurement values for acid value are values as measured in accordance with the “Japanese Industrial Standards (JIS) K0070-1992” unless otherwise stated. Measurement values for mass average molecular weight (Mw) are values as measured by gel permeation chromatography, unless otherwise stated.

In the following, measurement values for static surface tension are values as measured at 25° C. using a surface tensiometer (e.g., “STANDARD SURFACE TENSIOMETER DY-300”, product of Kyowa Interface Science Co., Ltd.) in accordance with the Wilhelmy Plate Method unless otherwise stated.

Measurement values for viscosity are values as measured at 25° C. using a falling ball viscometer (e.g., “LOVIS2000”, product of Anton Paar Japan K.K.), unless otherwise stated.

In the following, measurement values for pH are values as measured at 25° C. using a pH meter (e.g., “D-51”, product of HORIBA, Ltd.) unless otherwise stated.

In the present specification, the term “(meth)acryl” is used as a generic term for both acryl and methacryl. Each component described in this specification may be used alone or in combination of two or more. The expression “at least one of A and B” is synonymous with “either or both A and B”.

### First Embodiment: Recording Head Filling Liquid

The following describes a recording head filling liquid (also referred to below simply as filling liquid) according to a first embodiment of the present disclosure. A recording head filling liquid according to the present embodiment contains a specific moisturizing agent, a monovalent alkali, and water. The specific moisturizing agent is a compound represented by general formula (1) below. The specific moisturizing agent has a percentage content of at least 19.00% by mass and no greater than 42.00% by mass. The recording head filling liquid according to the present embodiment has a static surface tension at 25° C. of at least 20.0 mN/m and no greater than 29.0 mN/m.

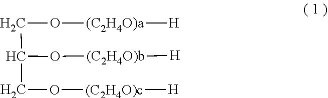

In general formula (1), a, b, and c each represent, independently of one another, an integer of at least 1 and a+b+c is at least 4 and no greater than 20.

The filling liquid according to the present embodiment is used to fill a recording head with an ink remaining therein. Specifically, the filling liquid according to the present embodiment is used to fill the recording head during its shipment, long-term storage, or transportation. The filling liquid according to the present embodiment is preferably used in an ink set according to a second embodiment or a recording head inspection method according to a third embodiment.

The filling liquid according to the present embodiment, having the features described above, can be easily introduced into an ink flow channel within the recording head, and effectively inhibit agglomeration of pigment components of the ink in the recording head. The filling liquid can also be purged stably. The reasons why the filling liquid according to the present embodiment achieves the effects described above are inferred as follows.

The recording head filling liquid according to the present embodiment contains a specific moisturizing agent, a monovalent alkali, and water. The filling liquid according to the present embodiment enters the ink flow channel of the recording head and dilutes the ink remaining in the ink flow channel. Therefore, solids of the ink remaining in the ink flow channel hardly agglomerate. In particular, the filling liquid according to the present embodiment contains the specific moisturizing agent represented by general formula (1). The specific moisturizing agent, represented by general formula (1) in which a+b+c is at least 4, has a low viscosity so as not to increase the pressure (purge pressure) on the recording head during purging of the filling liquid according to the present embodiment. Therefore, the filling liquid according to the present embodiment can be purged stably from the recording head even when the recording head has been left unused. Furthermore, although the reason is unclear, the study conducted by the present disclosers reveals that the moisturizing agent, represented by general formula (1) in which a+b+c exceeds 20, cannot sufficiently inhibit the agglomeration of the pigment components of the ink within the recording head. The filling liquid according to the present embodiment, containing the specific moisturizing agent represented by general formula (1) in which a+b+c is at least 4 and no greater than 20, can sufficiently inhibit agglomeration of the pigment components of the ink within the recording head and can be purged stably. In particular, the filling liquid according to the present embodiment, containing the specific moisturizing agent represented by general formula (1) with a percentage content of at least 19.00% by mass and no greater than 42.00% by mass, can effectively inhibit agglomeration of the pigment components of the ink within the recording head.

The filling liquid according to the present embodiment, which contains a monovalent alkali, can effectively inhibit agglomeration of the pigment components of the ink within the recording head, thereby ensuring high dispersion stability of the pigment components. The study conducted by the present disclosers reveals that the filling liquid without alkali cannot sufficiently inhibit agglomeration of the pigment components of the ink within the recording head. Containing a divalent alkali instead of a monovalent alkali in a filling liquid cannot ensure dispersion stability of the pigment components and cannot sufficiently inhibit agglomeration of the pigment components of the ink within the recording head.

The recording head filling liquid according to the present embodiment has a static surface tension at 25° C. of at least 20.0 mN/m and no greater than 29.0 mN/m. The filling liquid according to the present embodiment with a low static surface tension is easily introduced into the ink flow channel of the recording head. The following describes the filling liquid according to the present embodiment in more details.

The static surface tension of the recording head filling liquid according to the present embodiment at 25° C. should be at least 20.0 mN/m and no greater than 29.0 mN/m. Preferably, it is at least 27.0 mN/m and no greater than 29.0 mN/m, and more preferably at least 28.0 mN/m and no greater than 29.0 mN/m. The recording head filling liquid according to the present embodiment, with a static surface tension at 25° C. of at least 27.0 mN/m and no greater than 29.0 mN/m, can be reliably introduced into the flow channel of the recording head.

Preferably, the filling liquid according to the present embodiment has a pH of at least 7 and no greater than 10, and more preferably at least 8 and no greater than 9. The filling liquid according to the present embodiment, with a pH of at least 7 and no greater than 10, can more effectively inhibit agglomeration of the pigment components of the ink within the recording head.

### (Specific Moisturizing Agent)

The specific moisturizing agent of the present embodiment is a compound represented by general formula (1) indicated above. In general formula (1), a+b+c should be an integer of at least 4 and no greater than 20. Preferably, it is at least 6 and no greater than 18, more preferably at least 6 and no greater than 15, and further preferably at least 6 and no greater than 9. The filling liquid according to the present embodiment, containing the specific moisturizing agent with low viscosity (e.g., a specific moisturizing agent with a viscosity at 25° C. of no greater than 450 mPa·s), can be purged stably from the recording head even when the recording head has been left unused. Setting a+b+c in general formula (1) to be an integer of at least 4 and no greater than 20 can ensure high dispersion stability of the pigment components, thereby effectively inhibiting agglomeration of the pigment components of the ink within the recording head. Setting a+b+c in general formula (1) to be an integer of at least 6 and no greater than 18 can more effectively inhibit agglomeration of the pigment components of the ink within the recording head.

The specific moisturizing agent has a viscosity at 25° C. of preferably at least 260 mPa·s and no greater than 450 mPa·s, and more preferably at least 330 mPa·s and no greater than 450 mPa·s. Containing the specific moisturizing agent with a viscosity of at least 260 mPa·s and no greater than 450 mPa·s can effectively inhibit agglomeration of the pigment components of the ink within the recording head. The filling liquid can also be purged stably from the recording head even when the recording head has been left unused.

The specific moisturizing agent should have a percentage content of at least 19.0% by mass and no greater than 42.0% by mass in the filling liquid according to the present embodiment. Preferably, it is at least 27.0% by mass and no greater than 38.0% by mass, and more preferably at least 27.0% by mass and no greater than 33.0% by mass. Setting the percentage content of the specific moisturizing agent to be at least 19.0% by mass and no greater than 42.0% by mass in the filling liquid according to the present embodiment can effectively inhibit agglomeration of the pigment components of the ink within the recording head. Setting the percentage content of the specific moisturizing agent to be at least 27.0% by mass and no greater than 38.0% by mass in the filling liquid according to the present embodiment can more effectively inhibit agglomeration of the pigment components of the ink within the recording head.

### (Monovalent Alkali)

Examples of the monovalent alkali include sodium compounds, potassium compounds, lithium compounds, cesium compounds, and rubidium compounds. Examples of these monovalent alkali include hydroxides with alkali metal ion as cation, carbonate, and hydrogen carbonate. Examples of the sodium compounds include sodium hydroxide (NaOH), sodium carbonate (Na₂CO₃), and sodium hydrogen carbonate (NaHCO₃). Examples of the potassium compounds include potassium hydroxide (KOH), potassium carbonate (K₂CO₃), and potassium hydrogen carbonate (KHCO₃). Examples of the lithium compounds include lithium hydroxide (LiOH), lithium carbonate (Li₂CO₃), and lithium hydrogen carbonate (LiHCO₃). Examples of the cesium compounds include cesium hydroxide (CsOH), cesium carbonate (Cs₂CO₃), and cesium hydrogen carbonate (CsHCO₃). Examples of the rubidium compounds include rubidium hydroxide (RbOH), rubidium carbonate (Rb₂CO₃), and rubidium hydrogen carbonate (RbHCO₃). The monovalent alkali dissolves in water to be ionized into alkali metal ions and counter ions, thereby exhibiting basicity (pH ≥7). Preferably, the monovalent alkali is hydroxide, and particularly preferably sodium hydroxide.

The filling liquid according to the present embodiment, containing a monovalent alkali, can effectively inhibit agglomeration of the pigment components of the ink within the recording head, thereby ensuring high dispersion stability of the pigment components. In particular, the pigment components of the ink can exhibit high dispersion stability because of the filling liquid according to the present embodiment containing the specific moisturizing agent as a moisturizing agent. Therefore, the filling liquid according to the present embodiment offers a high degree of freedom in selection of anions that can be used as counter ions for alkali metal ions.

### (Water)

The water is the main solvent of the filling liquid according to the present embodiment. The water has a percentage content of preferably at least 45.00% by mass and no greater than 80.00% by mass in the filling liquid according to the present embodiment, and more preferably at least 60.00% by mass and no greater than 75.00% by mass, for example.

### (Surfactant)

Preferably, the filling liquid according to the present embodiment further contains a surfactant. The surfactant reduces the static surface tension of the filling liquid according to the present embodiment at 25° C., facilitating introduction of the filling liquid into the ink flow channel within the recording head. Preferably, the surfactant in the filling liquid according to the present embodiment is a nonionic surfactant. The nonionic surfactant contained in the filling liquid according to the present embodiment is preferably an acetylene glycol surfactant. The acetylene glycol surfactant optimizes wettability of the filling liquid according to the present embodiment to stainless steel, which is often used as the material for the flow channel of the recording head. Therefore, the filling liquid according to the present embodiment, which contains an acetylene glycol surfactant, is introduced further smoothly into the ink flow channel of the recording head. An example of the acetylene glycol surfactant contained in the filling liquid according to the present embodiment is “OLFINE® E1010”, which is ethylene oxide adduct of acetylene glycol produced by Nissin Chemical Industry Co., Ltd.

The surfactant has a percentage content of preferably at least 0.05% by mass and no greater than 0.10% by mass in the filling liquid according to the present embodiment, and more preferably at least 0.05% by mass and no greater than 0.07% by mass. The filling liquid according to the present embodiment, which contains a surfactant with a percentage content of at least 0.05% by mass, is introduced further smoothly into the ink flow channel of the recording head and can effectively inhibit agglomeration of the pigment components of the ink within the recording head. Conversely, an excessive amount of a surfactant may reduce dispersion stability of the pigment components of the ink. Therefore, the filling liquid according to the present embodiment, containing a surfactant with a percentage content of no greater than 0.10% by mass, can further effectively inhibit agglomeration of the pigment components of the ink within the recording head.

### (Other Components)

The filling liquid may further contain known additives (e.g., a solution stabilizer, an anti-drying agent, an antioxidant, a viscosity modifier, a pH adjuster, and an antifungal agent) as necessary.

### (Preferable Composition)

Preferably, the filling liquid according to the present embodiment has one of Compositions 1 to 13 shown below in Table 1. Note that, in Table 1 below, “Percentage” column refers to a preferable numerical range of the percentage content [% by mass]. For example, the numerical range of “27.0-33.0”, which is a percentage content range of the specific moisturizing agent in Composition 1, indicates that the specific moisturizing agent is contained in a range of at least 27.0% by mass to no greater than 33.0% by mass. “M-2”, “M-3”, “M-4”, and “M-5” as the types of the specific moisturizing agent respectively refer to specific moisturizing agents (M-2), (M-3), (M-4), and (M-5) used in Examples.

TABLE 1

| | Specific moisturizing agent | | Alkali | | Surfactant | Water |
|---|---|---|---|---|---|---|
| Composition | Type | Percentage | Type | Percentage | Percentage | Percentage |
| 1 | M-2 | 27.00-33.00 | NaOH | pH adjusted | 0.05-0.07 | Rest |
| 2 | M-3 | 27.00-33.00 | NaOH | to 8 to 9 | 0.05-0.07 | Rest |
| 3 | M-4 | 27.00-33.00 | NaOH | (trace | 0.05-0.07 | Rest |
| 4 | M-5 | 27.00-33.00 | NaOH | amounts) | 0.05-0.07 | Rest |
| 5 | M-2 | 18.00-22.00 | NaOH | | 0.05-0.07 | Rest |
| 6 | M-2 | 36.00-44.00 | NaOH | | 0.05-0.07 | Rest |
| 7 | M-3 | 32.00-38.00 | NaOH | | 0.05-0.07 | Rest |
| 8 | M-3 | 32.00-38.00 | KOH | | 0.05-0.07 | Rest |
| 9 | M-3 | 32.00-38.00 | LiOH | | 0.05-0.07 | Rest |
| 10 | M-3 | 32.00-38.00 | CsOH | | 0.05-0.07 | Rest |
| 11 | M-3 | 32.00-38.00 | RbOH | | 0.05-0.07 | Rest |
| 12 | M-3 | 32.00-38.00 | NaOH | | 0.05-0.06 | Rest |
| 13 | M-3 | 32.00-38.00 | NaOH | | 0.07-0.09 | Rest |

### (Filling Liquid Production Method)

The filling liquid according to the present embodiment can be produced by mixing the specific moisturizing agent, the monovalent alkali, water, and a component (e.g., a surfactant) added as necessary, for example. The specific moisturizing agent can be produced by etherification by reacting polyethylene glycol and glycerin within the temperature range of 180° C. to 220° C.

### Second Embodiment: Ink Set

The following describes an ink set according to a second embodiment of the present disclosure. The ink set according to the present embodiment includes an ink and the filling liquid according to the first embodiment. Note that details of the filling liquid are omitted as they were already described in the first embodiment.

The ink set according to the present embodiment, including the filling liquid according to the first embodiment, facilitates introduction of the filling liquid into the ink flow channel within the recording head, effectively inhibiting agglomeration of the pigment components of the ink within the recording head. The filling liquid can also be purged stably.

### [Ink]

The ink contains a pigment, a pigment coating resin, and water. The pigment in the ink constitutes pigment particles together with the pigment coating resin, for example. The pigment particles are dispersed in a solvent. In view of optimizing color density, hue, or stability of the ink, the D₅₀ of the pigment particles is at least 30 nm and no greater than 250 nm, and more preferably at least 70 nm and no greater than 130 nm.

### (Pigment)

Examples of the pigment contained in the ink include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically 15:3). Examples of the violet pigments include C.I. Pigment Violet (19, 23, or 33). Examples of the black pigments include C.I. Pigment Black (7).

The pigment has a percentage content of preferably at least 2.00% by mass and no greater than 15.00% by mass in the ink, and more preferably at least 5.00% by mass and no greater than 10.00% by mass. Containing pigment with a percentage content of at least 2.00% by mass facilitates formation of images with desired image density. Containing the pigment with a percentage content of no greater than 15.00% by mass ensures fluidity of the ink.

### (Pigment Coating Resin)

The pigment coating resin is soluble in the ink. A portion of the pigment coating resin is present on the surfaces of pigment particles to impart the pigment particles with dispersibility, for example. Another portion of the pigment coating resin is present in a dissolved state in the ink, for example.

For example, the pigment coating resin is a copolymer of at least one monomer selected from (meth)acrylic acid alkyl ester, styrene, and vinylnaphthalene, and at least one monomer selected from (meth)acrylic acid and maleic acid.

The pigment coating resin is preferably a styrene-(meth)acrylic resin. The styrene-(meth)acrylic resin includes a styrene unit and a repeating unit derived at least one of monomers of (meth)acrylic acid alkyl ester and (meth)acrylic acid. Examples of the (meth)acrylic acid alkyl ester include methyl (meth)acrylate, ethyl (meth)acrylate, propyl (meth)acrylate, and butyl (meth)acrylate. The styrene-(meth)acrylic resin is preferably a copolymer (X) of styrene, methyl methacrylate, methacrylic acid, and butyl acrylate. The copolymer (X) is preferably neutralized with the equivalent amount of a basic compound (e.g. potassium hydroxide or sodium hydroxide).

In all repeating units included in the copolymer (X), the repeating unit derived from styrene has a percentage content of preferably at least 10.00% by mass and no greater than 20.00% by mass. In all the repeating units included in the copolymer (X), the repeating unit derived from methyl methacrylate has a percentage content of preferably at least 10.00% by mass and no greater than 20.00% by mass. In all the repeating units included in the copolymer (X), the repeating unit derived from methacrylic acid has a percentage content of preferably at least 35.00% by mass and no greater than 45.00% by mass. In all the repeating units included in the copolymer (X), the repeating unit derived from the butyl acrylate has a percentage content of preferably at least 25.00% by mass and no greater than 35.00% by mass.

The pigment coating resin has a percentage content of preferably at least 0.70% by mass and no greater than 6.00% by mass in the ink, and more preferably at least 2.00% by mass and no greater than 4.00% by mass. Containing the pigment coating resin with a percentage content of at least 0.70% by mass and no greater than 6.00% by mass can optimize ejection stability of the ink.

The pigment coating resin has an acid value of preferably at least 30 mgKOH/g and no greater than 300 mgKOH/g, and more preferably at least 50 mgKOH/g and no greater than 150 mgKOH/g. Containing the pigment coating resin with an acid value of at least 30 mgKOH/g and no greater than 300 mgKOH/g can optimize both dispersibility of the pigment particles (pigment components) and preservation stability of the ink.

The acid value of the pigment coating resin can be adjusted by changing the amounts of the monomers used in synthesizing the pigment coating resin. For example, in synthesis of the pigment coating resin, using the monomers (e.g., acrylic acid and methacrylic acid) with acidic functional groups (e.g., carboxy groups) can increase the acid value of the pigment coating resin.

The pigment coating resin has a Mw of at least 10,000 and no greater than 50,000, for example. Containing the pigment coating resin with a Mw of at least 10,000 and no greater than 50,000 can inhibit an increase in ink viscosity, thus allowing formation of images with desired image density.

The Mw of the pigment coating resin can be adjusted by changing conditions (specific conditions includes the amount of a polymerization initiator used, polymerization temperature, and polymerization time) for polymerizing the pigment coating resin.

In polymerization of the pigment coating resin, the amount of a polymerization initiator used is preferably at least 0.001 mol and no greater than 5 mol relative to 1 mol of a monomer mixture, and more preferably at least 0.01 mol and no greater than 2 mol.

For example, in polymerization of the pigment coating resin, the polymerization temperature can be set within a range of at least 50° C. to no greater than 70° C., and the polymerization time can be set within a range of at least 10 hours to no greater than 24 hours. Note that the polymerized pigment coating resin may be directly used as a raw material of the ink or after neutralization with an equivalent amount of a basic compound. The basic compound is preferably a hydroxide of alkali metal ions (e.g., NaOH).

### (Aqueous Medium)

The aqueous medium contained in the ink contains water. The aqueous medium may function either as a solvent or as a dispersion medium. An example of the aqueous medium is an aqueous medium that contains water and a water-soluble organic solvent.

The aqueous medium has a percentage content of preferably at least 30.00% by mass and no greater than 95.00% by mass in the ink, and more preferably at least 70.00% by mass and no greater than 95.00% by mass.

### (Water)

The water is the main solvent of ink. The water contained in the ink has a percentage content of preferably at least 20.00% by mass and no greater than 90.00% by mass, and more preferably at least 50.00% by mass and no greater than 80.00% by mass, for example.

### (Water-Soluble Organic Solvent)

Preferably, the ink further contains a water-soluble organic solvent. Examples of the water-soluble organic solvent contained in the ink include glycol compounds, glycol ether compounds, lactam compounds, nitrogen-containing compounds, acetate compounds, thiodiglycol, glycerin and dimethyl sulfoxide.

Examples of the glycol compounds include ethylene glycol, 1,3-propanediol, propylene glycol, 1,5-pentanediol, 1,2-octanediol, 1,8-octanediol, 3-methyl-1,5-pentanediol, diethylene glycol, triethylene glycol, and tetraethylene glycol.

Examples of the glycol ether compounds include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethylformamide.

An Example of the acetate compounds is diethylene glycol monoethyl ether acetate.

Preferably, the water-soluble organic solvent in the ink is 2-pyrrolidone or glycerin.

The water-soluble organic solvent has a percentage content of preferably at least 10.00% by mass and no greater than 80.00% by mass in the ink, and more preferably at least 20.00% by mass and no greater than 40.00% by mass. Containing the water-soluble organic solvent with a percentage content of at least 10.00% by mass and no greater than 80.00% by mass can optimize ejection stability of the ink.

### (Surfactant)

Preferably, the ink further contains a surfactant. The surfactant optimizes compatibility and dispersion stability of each component contained in the ink. The surfactant also imparts the ink with wettability to a recording medium. Preferably, the surfactant in the ink is a nonionic surfactant.

Examples of the nonionic surfactant in the ink include acetylene glycol surfactants (surfactants containing an acetylene glycol compound), silicone surfactants (surfactants containing a silicone compound), and fluorine surfactants (surfactants containing fluorine resin or a fluorine-containing compound). Examples of the acetylene glycol surfactants include ethylene oxide adducts of acetylene glycol and propylene oxide adducts of acetylene glycol.

When the ink contains a surfactant, the surfactant preferably has a percentage content of at least 0.10% by mass and no greater than 1.00% by mass, and more preferably at least 0.20% by mass and no greater than 0.40% by mass.

### (Additives)

The ink may further contain known additives (e.g., a solution stabilizer, an anti-drying agent, an antioxidant, a viscosity modifier, a pH adjuster, and an antifungal agent) as necessary.

### (Preferable Composition)

Preferably, the ink has one of compositions shown below in Table 2. Note that, in Table 2 below, the numerical range of “5.40-6.60”, which is a percentage content range of the pigment in Composition 1, indicates that the pigment is contained in a range of at least 5.40% by mass to no greater than 6.60% by mass. The expressions in other columns are also identical. The term “Resin” refers to pigment coating resin. “TGBE” refers to triethylene glycol mono-n-butyl ether.

TABLE 2

| | Percentage content [% by mass] | | | | | | |
|---|---|---|---|---|---|---|---|
| | | | | Aqueous medium | | | |
| Composition | Pigment | Resin | Surfactant | TGBE | 2-Pyrrolidone | Glycerin | Water |
| 1 | 5.40-6.60 | 2.20-2.60 | 0.20-0.40 | 3.60-4.40 | 4.50-5.50 | 18.00-22.00 | Rest |

### (Ink Production Method)

The ink can be produced by mixing a pigment dispersion containing the pigment, the aqueous medium, and an optional component (e.g., a surfactant) added as necessary, for example. The pigment dispersion contains the pigment, the pigment coating resin, and water. The pigment coating resin is prepared by neutralizing alkali-soluble resin with the equivalent amount of a basic compound (e.g., sodium hydroxide). The pigment dispersion can be prepared by adding the pigment to an aqueous solution containing the pigment coating resin, followed by dispersion treatment. A bead mill is used for dispersion treatment, for example. In ink production, after dispersion treatment, foreign matter and coarse particles may be removed using a filter (e.g., a filter with a pore size of no greater than 5 μm).

### Third Embodiment: Recording Head Inspection Method

The following describes a recording head inspection method according to a third embodiment of the present disclosure. The recording head inspection method of the present disclosure uses the ink set according to the second embodiment and includes an inspection process of inspecting ejection performance of a recording head, and a filling process of filling the recording head filling liquid according to the first embodiment to the recording head after the inspection process. In the inspection process, the ejection performance of the recording head is inspected by causing the recording head to eject the inkjet ink. The recording head inspection method according to the present embodiment can use the same ink set as used in the second embodiment. The recording head inspection method according to the present embodiment can use the same filling liquid as used in the first embodiment. Therefore, duplicate description is be omitted.

The recording head inspection method according to the present embodiment, which uses the ink set according to the second embodiment, can inhibit occurrence of ejection failure in the recording head following inspection. The recording head inspection method of the present embodiment is carried out before shipment of the recording head by a manufacturer, for example. The recording head used in the recording head inspection method of the present embodiment can be any recording head and may be, but not limited to, a piezoelectric inkjet recording head or a thermal inkjet recording head. The recording head is a line recording head, for example.

### [Inspection Process]

In the present process, ejection performance of the recording head is inspected. Specifically, in the present process, the recording head is allowed to eject the ink for inspection of ejection performance. There is ink remaining in the ink flow channel of the recording head inspected by the present process.

In the present process, the recording head may be washed after the inspection. The method for washing the recording head is not limited and may be a method in which a wash fluid is filled into the recording head and then ejected from the recording head, for example. Examples of the wash fluid include water and a wash fluid containing a water-soluble organic solvent. In the present process, it is challenging to completely remove the ink from the ink flow channel of the recording head even through washing.

### [Filling Process]

In the present process, the filling liquid according to the first embodiment is filled into the recording head. After the present process, the recording head is either stored in preparation for shipping or transported for shipping, for example. After delivered to users, the filling liquid according to the first embodiment can be expelled from the recording head by ejection.

### EXAMPLES

The following describes examples of present disclosure, but the present disclosure is not limited to these examples.

In Examples, the molecular weights (Mw) of the alkali soluble resin and the surfactants were measured using a gel permeation chromatography (“HLC-8020GPC”, product of Tosoh Corporation) under the following conditions. The calibration curve was plotted using n-propylbenzene and TSKgel standard polystyrenes from Tosoh Corporation, including F-40, F-20, F-4, F-1, A-5000, A-2500, and A-1000. Each pH of the filling liquids was measured at 25° C. using a pH meter (e.g., “D-51”, product of HORIBA, Ltd.) unless otherwise stated.

### (Measurement Conditions for Mass Average Molecular Weight)

Column: “TSKGEL SUPERMULTIPOREHZ-H” (semi-micro column with 4.6 mm I.D.×15 cm) produced by Tosoh Corporation
Number of columns: 3
Eluent: tetrahydrofuran
Flow rate: 0.35 mL/min
Sample injection volume: 10 μL
Measurement temperature: 40° C.
Detector: IR detector

### [Examination 1: Type of Moisturizing Agent in Filling Liquid]

First, the type of the moisturizing agent used in the recording head filling liquid was examined. The following is the preparation method of each raw material used in ink production.

### [Pigment Dispersion Preparation]

A pigment dispersion (D-1) was prepared for use in ink production. In preparation of the pigment dispersion (D-1), a pigment coating resin solution containing a pigment coating resin (R) and water was prepared first.

### (Preparation of Pigment Coating Resin Solution)

An alkali-soluble resin was prepared that included a repeating unit derived from methacrylic acid (MAA unit), a repeating unit derived from methyl methacrylate (MMA unit), a repeating unit derived from butyl acrylate (BA unit), and a repeating unit derived from styrene (ST unit). The alkali-soluble resin had a mass average molecular weight (Mw) of 20,000 and an acid value of 100 mgKOH/g. The mass ratio of each repeating unit in the alkali-soluble resin “MAA unit:MMA unit:BA unit:ST unit” was “40:15:30:15”. The alkali-soluble resin was mixed with a sodium hydroxide aqueous solution (neutralization treatment). Through the neutralization treatment, the alkali-soluble resin was neutralized with sodium hydroxide (NaOH). In the neutralization treatment, the amount of the sodium hydroxide aqueous solution required for neutralizing the alkali-soluble resin was 1.05 times the theoretical value of the amount of the sodium hydroxide aqueous solution. Thus, the alkali-soluble resin was neutralized with the equivalent amount (strictly speaking, 105% amount) of sodium hydroxide. As a result, a pigment coating resin solution containing water and a pigment coating resin (R), which is the neutralized alkali-soluble resin, was obtained.

### (Dispersion Treatment)

To achieve the composition shown below in Table 3, a magenta pigment (C.I. Pigment Red 122), the pigment coating resin solution containing the pigment coating resin (R), a surfactant A, and ion exchange water were charged into the vessel of a media type wet disperser (“DYNO®—MILL”, product of Willy A. Bachofen AG (WAB).

Note that the percentage content of “water” below in Table 3 indicates the total percentage content of water contained in the ion exchange water charged into the vessel and water contained in the pigment coating resin solution. The water contained in the pigment coating resin solution included water contained in the sodium hydroxide aqueous solution used to neutralize the alkali-soluble resin and water generated in the neutralization reaction between the alkali-soluble resin and the sodium hydroxide. The surfactant A was “OLFINE® E1010” (product of Nissin Chemical Industry Co., Ltd, ethylene oxide adduct of acetylene glycol) being an acetylene glycol surfactant (nonionic surfactant).

TABLE 3

| Pigment dispersion | Percentage content |
|---|---|
| (D-1) | [% by mass] |
| Magenta pigment | 15.00 |
| Pigment coating resin (R) | 6.00 |
| (neutralized with NaOH) | |
| Surfactant A | 0.50 |
| Water | 78.50 |
| Total | 100.00 |

The contents of the vessel were then wet dispersed. Zirconia beads (particle diameter 1.0 mm) were used as the medium. The amount of the media charged was 70% by volume relative to the vessel's capacity. The dispersion conditions included a temperature of 10° C. and a circumferential speed of 8 m/sec. The pigment dispersion was thus obtained.

The volume median diameter (D₅₀) of the pigment particles in the resulting pigment dispersion (D-1) was measured. Specifically, the resulting pigment dispersion (D-1) was diluted 300 times with ion exchange water, and the diluted mixture was used as a measurement sample. The D₅₀ of the pigment particles in the measurement sample was measured using a dynamic light scattering type particle size distribution analyzer (“ZETASIZER® NANO ZS”, product of Malvern Instruments Ltd.). The D₅₀ of the pigment particles in the measurement sample was used as the D₅₀ of the pigment particles in the pigment dispersion (D-1). Note that the measurement was performed 10 times, and the average value of the measured values was used as the D₅₀ of the pigment particles. The D₅₀ of the pigment particles in the pigment dispersion (D-1) was 100 nm.

### [Ink Preparation]

### [Preparation of Ink (I-1)]

Ion exchange water was charged into a flask equipped with a stirrer (“THREE ONE MOTOR® BL-600”, product of Shinto Scientific Co., Ltd.). The pigment dispersion (D-1), a surfactant B, triethylene glycol mono-n-butyl ether, 2-pyrrolidone, and glycerin were charged in the stated order while stirring the contents using the stirrer. Table 4 below shows the charge amount ratio of each raw materials. Note that the surfactant B was “SURFYNOL® 420” (product of Nissin Chemical Industry Co., Ltd, ethylene oxide adduct of acetylene glycol) being an acetylene glycol surfactant (nonionic surfactant).

TABLE 4

| | Charge amount |
|---|---|
| Ink (I-1) | [% by mass] |
| Pigment dispersion (D-1) | 40.00 |
| Surfactant B | 0.30 |
| Triethylene glycol | 4.00 |
| mono-n-butyl ether | |
| 2-Pyrrolidone | 5.00 |
| Glycerin | 20.00 |
| Water | Rest |
| Total | 100.00 |

### [Preparation of Filling Liquids]

Filling liquids (F-1) to (F-12) were prepared by the following methods. Details of moisturizing agents (M-1) to (M-6) used in the preparation of the filling liquids (F-1) to (F-6) and (F-8) to (F-12) are described first.

### [Moisturizing Agents (M-1) to (M-6)]

Compounds shown in Table 5 below were prepared by the following methods and were used as moisturizing agents (M-1) to (M-6). Note that, each viscosity of the moisturizing agents (M-1) to (M-6) was measured using a falling ball viscometer (“LOVIS2000”, product of Anton Paar Japan K.K.) at 25° C.

### [Preparation of Moisturizing Agents (M-2) to (M-6)]

Polyethylene glycol and glycerin were reacted at 200° C. for etherification. Thus, compounds used as the moisturizing agents (M-2) to (M-6) shown in Table 5 were synthesized. The resulting compounds were confirmed to have at least 99% of peaks of glycerin and polyethylene glycol by high performance liquid chromatography (HPLC). Specifically, the resulting compounds each were added to and mixed with acetonitrile and water, and then quantitatively analyzed by HPLC under the following conditions. Note that the moisturizing agents (M-2) to (M-6) each were the specific moisturizing agent.
HPLC device: “HITACHI D-7000”, product of Hitachi High-Tech Science Corporation
Flow rate: 1.0 mL/min
Detector: “CORONA CAD DETECTOR”, product of ESA Biosciences

### (Conditions for Glycerin Analysis)

Column: “TSKGEL AMIDE-80”, product of Tosoh Corporation (5 μm, 4.6×250 mm)
Solution: 50% by volume of acetonitrile/water (distilled water)

### (Conditions for Polyethylene Glycol Analysis)

Column: “INERTSIL C8-3”, product of GL Sciences Inc. (5 μm, 4.6×150 mm)
Solution: acetonitrile/water (distilled water)

The volume rate of the acetonitrile in the solution was kept at 45% by volume for 3 minutes, and then a linear gradient was applied for 9 minutes until the volume rate of the acetonitrile increased from 45% by volume to 98% by volume. Thereafter, the volume rate of the acetonitrile was kept at 98% by volume. [Preparation of Moisturizing Agent (M-1)]

A compound as the moisturizing agent (M-1) shown in Table 5 was synthesized by the same method as that for synthesizing the moisturizing agents (M-2) to (M-6) except that ethylene glycol was used instead of polyethylene glycol. The resulting compound was confirmed to have at least 99% peaks of glycerin and ethylene glycol using the same method as that for the moisturizing agents (M-2) to (M-6).

TABLE 5

| Moisturizing agent | M-1 | M-2 | M-3 | M-4 | M-5 | M-6 |
|---|---|---|---|---|---|---|
| a + b + c | 3 | 6 | 9 | 15 | 18 | 21 |
| Viscosity [mPa · s] | 480 | 410 | 350 | 310 | 280 | 250 |

### [Preparation of Filling Liquid (F-1)]

A mixed liquid was obtained by mixing 30.00 parts by mass of the moisturizing agent (M-1), 0.06 parts by mass of a surfactant C, sodium hydroxide, and ion exchange water. The amount of sodium hydroxide added was adjusted to achieve an amount (trace amounts) that makes the mixed liquid have a pH of 8 to 9. The amount of the ion exchange water added was adjusted to bring the total amount of the mixed liquid to 100.00 parts by mass. The mixed liquid was used as a filling liquid (F-1). Note that the surfactant C was “OLFINE® Exp4300” (product of Nissin Chemical Industry Co., Ltd, nonionic surfactant) being an acetylene glycol surfactant.

### [Preparation of Filling Liquids (F-2) to (F-12)]

Filling liquids (F-2) to (F-12) were prepared by the same method as that for preparing the filling liquid (F-1), except that the type and amount of each component were changed as shown in Tables 6 and 7.

The static surface tension of each of the filling liquids (F-2) to (F-12) was measured at 25° C. using a surface tensiometer (“AUTOMATIC SURFACE TENSIOMETER DY-300”, product of Kyowa Interface Science Co., Ltd.) in accordance with the Wilhelmy Plate Method. The measurement results are also shown in Tables 6 and 7 below.

TABLE 6

| | | Filling liquid | | | | | |
|---|---|---|---|---|---|---|---|
| | | F-1 | F-2 | F-3 | F-4 | F-5 | F-6 |
| Moisturizing | Type | M-1 | M-2 | M-3 | M-4 | M-5 | M-6 |
| agent | a + b + c | 3 | 6 | 9 | 15 | 18 | 21 |
| | Viscosity [mPa · s] | 480 | 410 | 350 | 310 | 280 | 250 |
| | Percentage content | 30.00 | 30.00 | 30.00 | 30.00 | 30.00 | 30.00 |
| | [% by mass] | | | | | | |

| Percentage content of surfactant C | 0.06 | 0.06 | 0.06 | 0.06 | 0.06 | 0.06 |
|---|---|---|---|---|---|---|
| [% by mass] | | | | | | |
| Sodium hydroxide | pH adjusted to 8 to 9 (trace amounts) | | | | | |
| Percentage content of water | Rest | Rest | Rest | Rest | Rest | Rest |
| [% by mass] | | | | | | |
| Static surface tension [mN/m] | 28.4 | 28.5 | 28.3 | 28.2 | 28.0 | 29.5 |

TABLE 7

| | | Filling liquid | | | | | |
|---|---|---|---|---|---|---|---|
| | | F-7 | F-8 | F-9 | F-10 | F-11 | F-12 |
| Moisturizing | Type | Glycerin | M-2 | M-2 | M-2 | M-2 | M-2 |
| agent | a + b + c | — | 6 | 6 | 6 | 6 | 6 |
| | Viscosity [mPa · s] | 1400 | 410 | 410 | 410 | 410 | 410 |
| | Percentage content | 30.00 | 18.00 | 20.00 | 40.00 | 43.00 | 30.00 |
| | [% by mass] | | | | | | |

| Percentage content of surfactant C | 0.06 | 0.06 | 0.06 | 0.06 | 0.06 | 0.06 |
|---|---|---|---|---|---|---|
| [% by mass] | | | | | | |
| Sodium hydroxide | pH adjusted to 8 to 9 | | | | | No |
| | (trace amounts) | | | | | addition |
| Percentage content of water | Rest | Rest | Rest | Rest | Rest | Rest |
| [% by mass] | | | | | | |
| Static surface tension [mN/m] | 29.3 | 28.4 | 28.5 | 28.5 | 28.5 | 28.5 |

### [Preparation of Ink Sets]

As shown in Tables 8 and 9 below, the ink (I-1) and any one of the filling liquids (F-1) to (F-12) were combined. Thus, ink sets for Examples 1 to 6 and Comparative Examples 1 to 6 were prepared.

### [Evaluation 1]

Each of the ink sets of Examples 1 to 6 and Comparative Examples 1 to 6 were evaluated for the following performances using the methods described below. The performances evaluated include: agglomeration inhibition performance of the inks in an open system (with evaporation) and a closed system (without evaporation), indicating the capability of inhibiting agglomeration of the pigment components in each ink; purge ability of the filling liquids, indicating whether the filling liquid can be purged after a recording head has been left unused; and introducibility of the filling liquids, indicating the property of the filling liquid to be easily introduced into the ink flow channel within the recording head. The evaluation results are shown below in Tables 8 and 9.

### (Agglomeration Inhibition Performance in Open System)

In a beaker, 1.00 part by mass of the ink (ink (I-1) in Examination 1) was mixed with 50.00 parts by mass of the filling liquid (any of the filling liquids (F-1) to (F-12)), which were included in an ink set as an evaluation target. Next, the beaker containing the resulting mixed liquid was stored in a constant-temperature bath at 40° C. for one month without being sealed (storage treatment). The mixed liquid after the treatment was analyzed for the presence or absence of agglomerate with a particle size of at least 3 μm using a particle shape image analyzer (“FPIA®—3000” product of Malvern Panalytical).

Note that a filling liquid, filled into the recording head after recording head inspection, mixes with an ink remaining in the recording head. The mixing ratio of the residual ink to the filling liquid (amount of ink/amount of filling liquid) varies depending on the location within the recording head, but it is expected to be around 1/50 at most. Therefore, the mixing ratio of the residual ink to the filling liquid was set to 1.00 part by mass of the ink to 50.00 parts by mass of the filling liquid. Agglomerate with a particle size of at least 3 μm generated inside of the recording head may cause filter clogging, resulting in ink discharge failure. Therefore, generation of agglomerate with a particle size of at least 3 μm after the storage treatment was considered as a criterion for determination of inhibition of ink agglomeration.

### (Agglomeration Inhibition Performance in Closed System)

Evaluation of “Agglomeration Inhibition Performance in Closed System” was conducted by the same method as that for evaluation of “Agglomeration Inhibition Performance in Open System” described above except for the following changes. In the evaluation of “Agglomeration Inhibition Performance in Closed System”, the beaker was sealed with parafilm during storage to inhibit evaporation. The evaluation of “Agglomeration Inhibition Performance in Closed Systems” is conducted under milder conditions compared to those in “Agglomeration Inhibition Performance in Open System” due to the absence of concentration of pigment components caused by solvent evaporation.

### (Criteria for Determining Agglomeration Inhibition Performance)

A (Pass): no agglomerate with a particle size of at least 3 μm was generated after storage treatment in either open system or closed system.

B (Fail): agglomerate with a particle size of at least 3 μm was generated after storage treatment in at least one of open system and closed system.

### (Purge Ability)

When a filling liquid is purged from a recording head that has been left in a high-temperature environment, the viscosity of the filling liquid around the nozzle increases due to evaporation of the water-soluble organic solvent and water in the filling liquid inside the recording head. Higher viscosity of the filling liquid increases the pressure (purge pressure) on the recording head during purging of the filling liquid, leading to damage to the recording head. The study conducted by the present disclosers reveals that the viscosity of a moisturizing agent at 25° C. being no greater than 450 mPa·s allows a filling liquid to be purged smoothly, without increasing the purge pressure or causing damage to the recording head. Therefore, whether the viscosity of the moisturizing agent at 25° C. is no greater than 450 mPa·s was considered as a criterion for determining purge ability of the filling liquid. Purge ability of the filling liquid indicates whether the filling liquid can be purged after the recording head has been left unused.

### (Criteria for Determining Purge Ability)

A (Pass): viscosity of moisturizing agent at 25° C. of no greater than 450 mPa·s
B (Fail): viscosity of moisturizing agent at 25° C. of greater than 450 mPa·s

### (Introducibility)

First, an ink was filled into an unused recording head (“KJ4B-QA”, product of KYOCERA Corporation, total number of nozzles: 2656) and ejected therefrom. The ink used was the ink (I-1). Next, the recording head was washed with pure water and then completely dried. Next, 25 mL of the filling liquid (any of the filling liquids (F-1) to (F-12)), which was included in the ink set being an evaluation target, was filled into the recording head. Then, the filling liquid was expelled from the recording head by ejecting. This process was performed 10 times in total, with a total of 250 mL for filling. Then, the filling liquid was refilled into the recording head. Thereafter, a nozzle check pattern was printed on a glass plate using the recording head filled with the filling liquid. Thus, the nozzle check pattern was formed on the glass plate with the filling liquid. Next, the number of ejection nozzles that ejected the filling liquid (number of ejection nozzles) was counted by scanning the glass plate using a scanner. The rate [%] (introduction rate) of the number of ejection nozzles to the total number (2656) of nozzles of the recording head was calculated using the following equation. Introductivity of the filling liquid was determined according to the following criteria.

Introduction rate=100×Number of ejection nozzles/Total number of nozzles

### (Criteria for Determining Introducibility)

A (Pass): introducibility of at least 90%
B (Fail): introducibility of less than 90%

TABLE 8

| | Comparative | Example | Example | Example | Example | Comparative |
|---|---|---|---|---|---|---|
| | Example 1 | 1 | 2 | 3 | 4 | Example 2 |
| Type of ink | I-1 | I-1 | I-1 | I-1 | I-1 | I-1 |
| Type of filling | F-1 | F-2 | F-3 | F-4 | F-5 | F-6 |
| liquid | | | | | | |
| Viscosity of | 480 | 410 | 350 | 310 | 280 | 250 |
| moisturizing agent | | | | | | |
| [mPa · s] | | | | | | |
| Static surface | 28.4 | 28.5 | 28.3 | 28.2 | 28.0 | 29.5 |
| tension of filling | | | | | | |
| liquid [mN/m] | | | | | | |
| Agglomeration | A | A | A | A | A | B |
| inhibition | | | | | | |
| performance | | | | | | |
| Purge ability | B | A | A | A | A | A |
| Introducibility | A | A | A | A | A | A |

TABLE 9

| | Comparative | Comparative | Example | Example | Comparative | Comparative |
|---|---|---|---|---|---|---|
| | Example 3 | Example 4 | 5 | 6 | Example 5 | Example 6 |
| Type of ink | I-1 | I-1 | I-1 | I-1 | I-1 | I-1 |
| Type of filling | F-7 | F-8 | F-9 | F-10 | F-11 | F-12 |
| liquid | | | | | | |
| Viscosity of | 1400 | 480 | 410 | 410 | 410 | 410 |
| moisturizing | | | | | | |
| agent [mPa · s] | | | | | | |
| Static surface | 29.3 | 28.4 | 28.5 | 28.5 | 28.5 | 28.5 |
| tension of | | | | | | |
| filling liquid | | | | | | |
| [mN/m] | | | | | | |
| Agglomeration | A | B | A | A | B | B |
| inhibition | | | | | | |
| performance | | | | | | |
| Purge ability | B | A | A | A | A | A |
| Introducibility | A | A | A | A | A | A |

As shown in Tables 3 to 9, purge ability of the filling liquid is rated as fail when a+b+c is less than 4 in the moisturizing agent represented by general formula (1). By contrast, adequate agglomeration inhibition performance cannot be achieved when a+b+c exceeds 20 in the moisturizing agent represented by general formula (1). Therefore, it was determined that a+b+c in general formula (1) representing the moisturizing agent is preferably at least 4 and no greater than 20.

As shown in Tables 3 to 9, adequate agglomeration inhibition performance cannot be achieved when the percentage content of the specific moisturizing agent in the filling liquid is either less than 19.00% by mass or greater than 42.00% by mass. Therefore, it was determined that the percentage content of the specific moisturizing agent is preferably at least 19.00% by mass and no greater than 42.00% by mass in the filling liquid.

As shown in Tables 5 to 7, it was determined that adequate agglomeration inhibition performance cannot be achieved when the filling liquid does not contain alkali.

### [Examination 2: Types of Alkali in Filling Liquid]

Next, the types of alkali were examined.

### [Preparation of Filling Liquids (F-13) to (F-18)]

Filling liquids (F-13) to (F-18) were prepared by the same method as that for preparing the filling liquid (F-1), except that the type and amount of each component were changed as shown in Tables 10 and 11. The static surface tension of each of the filling liquids (F-13) to (F-18) was measured by the same method as that of filling liquids (F-1) to (F-12). The measurement results are also shown in Tables 10 and 11 below.

TABLE 10

| Filling liquid | | F-13 | F-14 | F-15 |
|---|---|---|---|---|
| Moisturizing | Type | M-3 | M-3 | M-3 |
| agent | Percentage content | 35.00 | 35.00 | 35.00 |
| | [% by mass] | | | |
| Percentage content of surfactant C | | 0.06 | 0.06 | 0.06 |
| [% by mass] | | | | |
| Alkali | Type | NaOH | KOH | LiOH |

| | |
|---|---|
| Amount | pH adjusted to 8 to 9 |
| | (trace amounts) |

| | | | |
|---|---|---|---|
| Percentage content of water [% by mass] | Rest | Rest | Rest |
| Static surface tension [mN/m] | 27.4 | 27.6 | 27.5 |

TABLE 11

| Filling liquid | | F-16 | F-17 | F-18 |
|---|---|---|---|---|
| Moisturizing | Type | M-3 | M-3 | M-3 |
| agent | Percentage content | 35.00 | 35.00 | 35.00 |
| | [% by mass] | | | |
| Percentage content of surfactant C | | 0.06 | 0.06 | 0.06 |
| [% by mass] | | | | |
| Alkali | Type | CsOH | RbOH | Mg(OH)₂ |

| | |
|---|---|
| Amount | H adjusted to 8 to 9 |
| | (trace amounts) |

| | | | |
|---|---|---|---|
| Percentage content of water [% by mass] | Rest | Rest | Rest |
| Static surface tension [mN/m] | 27.4 | 27.8 | 27.5 |

### [Preparation of Ink Sets]

As shown in Table 12 below, the ink (I-1) and any one of the filling liquids (F-13) to (F-18) were combined. Thus, ink set for Examples 7 to 11 and Comparative Example 7 were prepared.

### [Evaluation 2]

The ink sets of Examples 7 to 11 and Comparative Example 7 were evaluated for agglomeration inhibition performance of each of the inks, purge ability of each of the filling liquids, and introducibility of each of the filling liquids by the same method as described in the former section [Evaluation 1]. The evaluation results are shown in Table 12 below.

TABLE 12

| | Example | Example | Example | Example | Example | Comparative |
|---|---|---|---|---|---|---|
| | 7 | 8 | 9 | 10 | 11 | Example 7 |
| Type of ink | I-1 | I-1 | I-1 | I-1 | I-1 | I-1 |
| Type of filling | F-13 | F-14 | F-15 | F-16 | F-17 | F-18 |
| liquid | | | | | | |
| Static surface | 27.4 | 27.6 | 27.5 | 27.4 | 27.8 | 27.5 |
| tension of filling | | | | | | |
| liquid [mN/m] | | | | | | |
| Agglomeration | A | A | A | A | A | B |
| inhibition | | | | | | |
| performance | | | | | | |
| Purge ability | A | A | A | A | A | A |
| Introducibility | A | A | A | A | A | A |

As shown in Tables 10 to 12, no agglomerate with a particle size of at least 3 μm was observed in the mixed liquids of the ink (I-1) and any one of the filling liquids (F-13) to (F-17) after the storage treatment because the filling liquids (F-13) to (F-17) each contained a monovalent alkali. By contrast, the filling liquid (F-18), containing a divalent alkali, did not ensure dispersion stability of the pigment components, thereby failing to inhibit generation of agglomerate with a particle size of at least 3 μm after the storage treatment. Therefore, it was determined that the filling liquid, containing a monovalent alkali, can effectively inhibit agglomeration of the pigment components of the ink within the recording head, thereby ensuring high dispersion stability of the pigment components.

### [Examination 3: Static Surface Tension of Filling Liquid]

Next, the static surface tension of filling liquid was examined.

### [Preparation of Filling Liquids (F-19) to (F-23)]

Filling liquids (F-19) to (F-23) were prepared by the same method as that for preparing the filling liquid (F-1), except that the type and amount of each component were changed as shown in Table 13 below. The measurement method for the static surface tension of the filling liquids (F-19) to (F-23) was the same as that of the filling liquids (F-1) to (F-18). The measurement results are also shown below in Table 13.

TABLE 13

| Filling liquid | | F-19 | F-20 | F-21 | F-22 | F-23 |
|---|---|---|---|---|---|---|
| Moisturizing | Type | M-3 | M-3 | M-3 | M-3 | M-3 |
| agent | Percentage content | 35.00 | 35.00 | 35.00 | 35.00 | 35.00 |
| | [% by mass] | | | | | |

| Percentage content of surfactant C | 0.01 | 0.02 | 0.04 | 0.05 | 0.08 |
|---|---|---|---|---|---|
| [% by mass] | | | | | |
| Sodium hydroxide | pH adjusted to 8 to 9 (trace amounts) | | | | |
| Percentage content of water | Rest | Rest | Rest | Rest | Rest |
| [% by mass] | | | | | |
| Static surface tension of filling liquid | 41.0 | 36.0 | 31.0 | 28.5 | 27.2 |
| [mN/m] | | | | | |

### [Preparation of Ink Sets]

As shown in Table 14 below, the ink (I-1) and any one of the filling liquids (F-19) to (F-23) were combined. Thus, ink sets for Examples 12 and 13 and Comparative Examples 8 to 10 were prepared.

### [Evaluation 3]

The ink sets of Examples 12 and 13 and Comparative Examples 8 to 10 were evaluated for agglomeration inhibition performance of each of the inks, the purge ability of each of the filling liquids, and introducibility of each of the filling liquids by the same methods as described in the former section [Evaluation 1]. The evaluation results are shown below in Table 14.

TABLE 14

| | Comparative Examples | | | Examples | |
|---|---|---|---|---|---|
| | 8 | 9 | 10 | 12 | 13 |
| Type of ink | I-1 | I-1 | I-1 | I-1 | I-1 |
| Type of filling liquid | F-19 | F-20 | F-21 | F-22 | F-23 |
| Static surface tension of | 41.0 | 36.0 | 31.0 | 28.5 | 27.2 |
| filling liquid [mN/m] | | | | | |
| Agglomeration inhibition | A | A | A | A | A |
| performance | | | | | |
| Purge ability | A | A | A | A | A |
| Introducibility | B | B | B | A | A |

As shown in Tables 13 and 14, the filling liquids (F-22) and (F-23) respectively used in Examples 12 and 13 each had a static surface tension at 25° C. of at least 20.0 mN/m and no greater than 29.0 mN/m. The filling liquids used in the ink sets of Examples 12 and 13 both were smoothly introduced into the ink flow channel within the recording head. By contrast, the filling liquids (F-19) to (F-21) respectively used in Comparative Examples 8 to 10 each had a static surface tension at 25° C. of greater than 29.0 mN/m. As a result, the filling liquids of the ink sets of Comparative Examples 8 to 10 were difficult to introduce into the ink flow channel within the recording head. Therefore, it was determined that the filling liquid with a static surface tension at 25° C. of at least 20.0 mN/m and no greater than 29.0 mN/m can be effectively introduced.

As shown in Tables 13 to 14, the static surface tension at 25° C. of the filling liquid can be adjusted by changing the percentage content of the nonionic surfactant (surfactant C in Examination 3). The nonionic surfactant reduces the static surface tension of the filling liquid at 25° C., facilitating introduction of the filling liquid into the ink flow channel within the recording head. As shown in Table 13, setting the percentage content of the nonionic surfactant in the filling liquid to be at least 0.05% by mass and no greater than 0.10% by mass facilitates adjustment of the static surface tension of the filling liquid to be at least 20.0 mN/m and no greater than 29.0 mN/m.

What is claimed is:

1. A recording head filling liquid comprising:
a specific moisturizing agent;
a monovalent alkali; and
water, wherein
the specific moisturizing agent is a compound represented by general formula (1) below,
the specific moisturizing agent has a percentage content of at least 19.00% by mass and no greater than 42.00% by mass, and
the recording head filling liquid has a static surface tension at 25° C. of at least 20.0 mN/m and no greater than 29.0 mN/m: 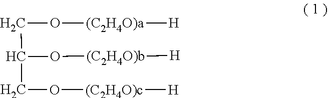
where in the general formula (1), a, b, and c each represent, independently of one another, an integer of no greater than 1 and a+b+c is at least 4 to no greater than 20.

2. The recording head filling liquid according to claim 1, wherein
the specific moisturizing agent has a viscosity at 25° C. of at least 260 mPa·s and no greater than 450 mPa·s.

3. The recording head filling liquid according to claim 1, wherein
the monovalent alkali includes at least one of a sodium compound, a potassium compound, a lithium compound, a cesium compound, and a rubidium compound.

4. The recording head filling liquid according to claim 1, wherein
in the general formula (1), a+b+c is at least 6 and no greater than 18.

5. The recording head filling liquid according to claim 1, further comprising
a nonionic surfactant, wherein
the nonionic surfactant includes an acetylene glycol surfactant.

6. The recording head filling liquid according to claim 5, wherein
the nonionic surfactant has a percentage content of at least 0.05% by mass and no greater than 0.10% by mass.

7. The recording head filling liquid according to claim 1, wherein
the recording head filling liquid has a pH of at least 7 and no greater than 10.

8. The recording head filling liquid according to claim 1, wherein
the filling liquid is used to fill a recording head while inkjet ink remaining therein.

9. An ink set comprising:
an inkjet ink; and
the recording head filling liquid according to claim 1.

10. The ink set according to claim 9, wherein
the inkjet ink contains a pigment, a pigment coating resin, and an aqueous medium.

11. A recording head inspection method that uses the ink set according to claim 9, comprising:
inspecting ejection performance of a recording head; and
filling the recording head filling liquid into the recording head after the inspecting, wherein
in the inspecting, the ejection performance of the recording head is inspected by causing the recording head to eject the inkjet ink.

12. The recording head inspection method according to claim 11, wherein
the recording head is a line recording head.
